(19) United States
(12) Patent Application Publication
(10) Pub. No.: US 2016/0081086 A1
(43) Pub. Date: Mar. 17, 2016

(54) INFORMATION OUTPUT DEVICE AND COMPUTER-READABLE MEDIUM

(71) Applicant: CASIO COMPUTER CO., LTD., Tokyo (JP)

(72) Inventor: Hirokiyo KASAHARA, Tokyo (JP)

(73) Assignee: CASIO COMPUTER CO., LTD., Tokyo (JP)

(21) Appl. No.: 14/830,477

(22) Filed: Aug. 19, 2015

(30) Foreign Application Priority Data
Sep. 12, 2014 (JP) 2014-185928

(51) Int. Cl. H04W 72/04; H04W 76/02

(52) U.S. Cl. CPC H04W 72/0446; H04W 76/021

(57) ABSTRACT

An information output device includes an acquisition unit (control unit) and an output unit. The acquisition unit acquires, from a communication terminal, information on a use period of the communication terminal through communication therewith. The output unit outputs information based on the acquired information on the use period. An information output method includes a step of acquiring, from a communication terminal, information on a use period of the communication terminal through communication therewith and a step of outputting information based on the information on the use period. A non-transitory computer-readable storage medium storing a program according to an embodiment of the present invention executes a function to acquire, from a communication terminal, information on a use period of the communication terminal through communication therewith and a function to output information based on the information on the use period.

### BACKGROUND

1. Technical Field

This invention relates to an information output device and computer-readable medium.

2. Related Art

In the related art, a technique is known whereby images are output by a projection apparatus (e.g. projector) according to data from an information terminal for the purpose of advertisement or publicity.

For example, JP 2011-150221 A discloses a technique whereby a video output device connected to a video supply device is mounted on an apparatus for mounting the video output device and projects output light onto a screen. A reflection member provided to the apparatus for mounting the video output device reflects the output light projecting content from the video output device, thereby projecting the output light reflected by the reflection member onto the screen formed in the shape of an outline of the content.

The technique of JP 2011-150221 A allows for projecting the content onto the screen formed in the shape of the outline of the content. This can enhance the picture of the output video or image, resulting in a customer-attracting effect or the like.

However, the related art including that of JP 2011-150221 A unilaterally outputs information from an information terminal. This does not always meet the needs of viewers.

### SUMMARY

The present invention has been made in consideration of such circumstances with an objective of outputting information that meets the needs of users.

The present invention includes the following configuration in order to achieve the above-described objective.

An information output device according to an embodiment of the invention includes an acquisition unit and an output unit. The acquisition unit acquires, from a communication terminal, information on a use period of the communication terminal through communication therewith. The output unit outputs information based on the acquired information on the use period.

According to an embodiment of the invention, information that meets the needs of users can be output.

### BRIEF DESCRIPTION OF THE DRAWINGS

FIG. 1 is a general perspective view showing a configuration of an information output device according to an embodiment of the invention;

FIG. 2 is a cross-sectional view of the information output device taken along line I-I in FIG. 1;

FIG. 3 is a block diagram showing a functional configuration of the information output device according to the embodiment of the invention; and

FIG. 4 is a flowchart showing operations of the information output device according to the embodiment of the invention.

### DETAILED DESCRIPTION

An embodiment of the invention (hereinafter referred to as the embodiment) will be described below in detail with reference to the accompanying drawings. Note that the same numerals or symbols are assigned to the same elements throughout the description of the embodiment.

An information output device according to the embodiment will be described below with reference to the drawings.

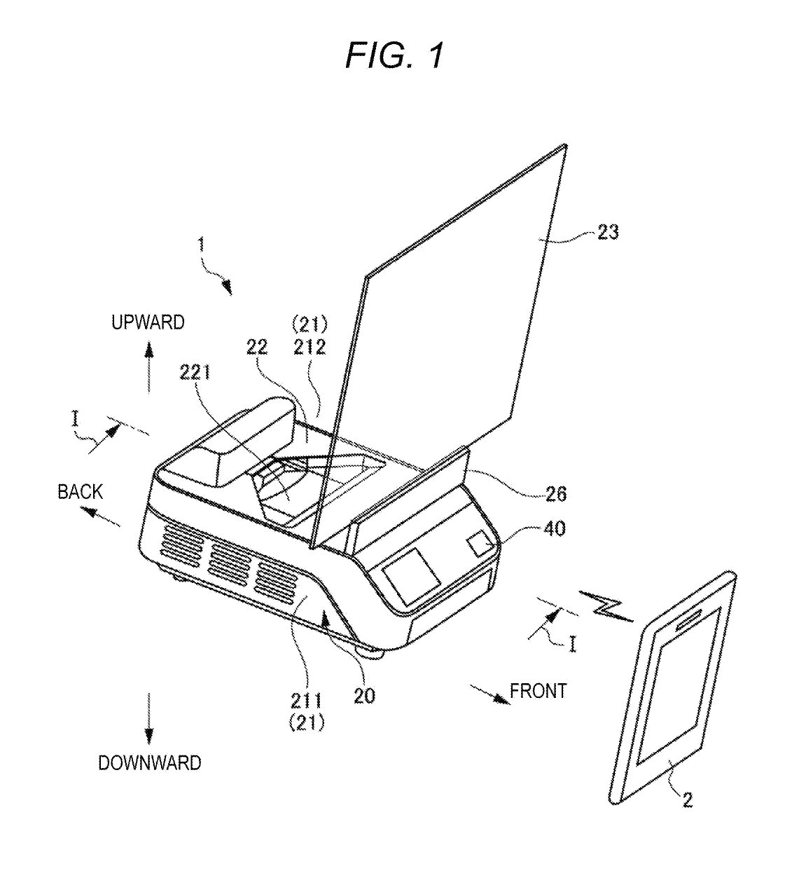

As shown in FIG. 1, an information output device 1 according to the embodiment acquires model information of a communication terminal 2 through communication with the communication terminal 2. The model information includes a model name, performance, a use period, etc. of the communication terminal 2.

Communication with the communication terminal 2 is performed by, for example, a near field communication (NFC) panel 40 for which a near field wireless communication interface is included in the information output device 1 and a near field wireless communication interface included in the communication terminal 2, which performs non-contact communication conforming to NFC. NFC is an international standard for near field wireless communication.

For description of the embodiment, it is assumed that a user possessing the communication terminal 2 is visiting a shop dealing with the communication terminal 2.

When the user places the communication terminal 2 over the NFC panel 40 included in the information output device 1 installed at the shop, the information output device 1 reads the model information (model name, performance, use period. etc.) of the communication terminal 2.

Based on the read information on the use period of the communication terminal 2, the information output device 1 outputs explanatory information on functions of the communication terminal 2 that the user currently possesses or on functions of other related models. Details will be described later.

Next, an external structure of the information output device 1 according to the embodiment will be described. As shown in FIG. 1, the information output device 1 according to the embodiment includes a housing 20 having an overall shape of a substantially rectangular box.

Note that, when the housing 20 is placed on a table or the like, the upward direction (upper side) is referred to as “upward direction (upper side)” and the side of a screen 23 is referred to as front (front side) while the opposite side is referred to as back (back side) in the following description. The screen 23 will be described later.

The housing 20 includes a lateral plate 21 covering all sides of the housing 20 and an opening in the upward direction.

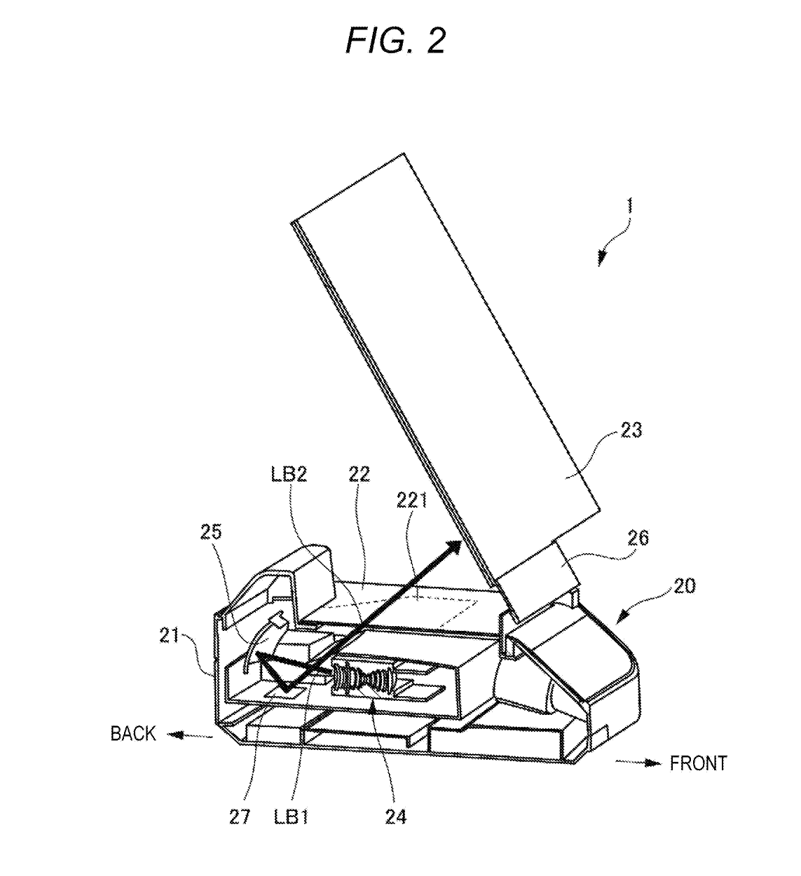

Note that, in FIG. 1, although a position of a transparent part 221 is shown, the transparent part 221 itself is not shown. As for a drawing including the transparent part 221, FIG. 2 is to be referred to.

As shown in FIG. 2, a panel 22 is attached to the opening. The panel 22 includes, in the center thereof, the transparent part 221 that transmits light. Parts other than the transparent part 221 are made to hide the inner part of the housing 20 by, for example, being printed in black.

Note that the panel 22 includes a transparent flat plate made of resin and is made to shield light by being printed in black or the like in parts other than the transparent part 221 on the surface facing the inner side of the housing 20. However, this printing in black or the like is not a requirement and the entire part of the panel 22 may be the transparent part 221.

Also, a right lateral plate 211 (one side) of the housing 20 is provided with a slit-shaped inlet and a left lateral plate 212 (the other side) is provided with a slit-shaped outlet.

Furthermore, the front of the housing 20 is provided with the NFC panel 40 that communicates with the communication terminal 2. Near field wireless communication with the communication terminal 2 is made possible via this NFC panel 40.

As shown in FIG. 2, a projection unit 24, which generates projection light and projects the light toward the back of the housing 20, is provided substantially in the center of the inner part of the housing 20. In the back of the housing 20, a first minor 25 having a concave reflecting surface is provided such that the projection light from the projection unit 24 is reflected to a second mirror 27 having a flat reflecting surface and that the projection light reflected by the second mirror 27 is then reflected onto the screen 23.

Therefore, the projection light (image) LB1 emitted from the projection unit 24 is reflected downward by the first mirror 25 and then reflected upward by the second minor 27 to pass through the transparent part 221 of the panel 22 and to be projected onto the screen 23 (projection light LB2) provided outside the housing 20.

The screen 23 for showing the projected image is turnably supported by a screen mounting part 26. The screen 23 can be in an upright position when in use and be folded down to the side of the housing 20 when not in use.

(Configuration of Information Output Device)

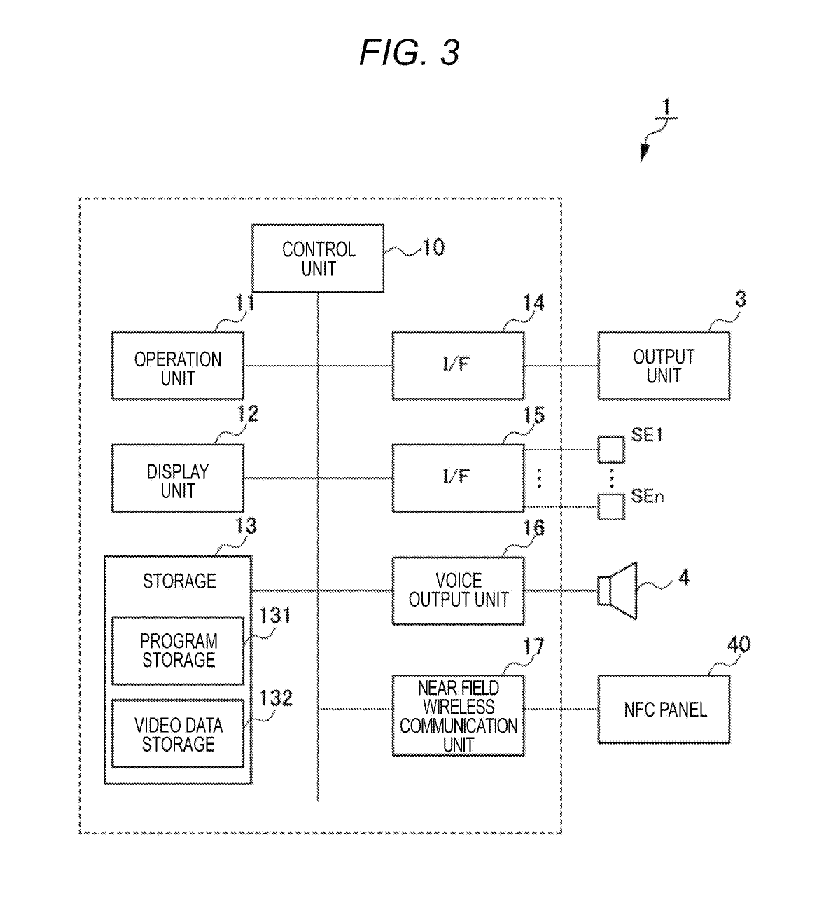

FIG. 3 is a block diagram showing a functional configuration of the information output device 1. As shown in FIG. 3, the information output device 1 includes a control unit 10, an operation unit 11, a display unit 12, a storage 13, an interface (hereinafter referred to as I/F 14), another interface (hereinafter referred to as I/F 15), a voice output unit 16, and a near field wireless communication unit 17.

Note that the information output device 1 is connected to an output unit 3 via the I/F 14, a human body sensor SE via the I/F 15, the NFC panel 40 via the near field wireless communication unit 17, and a speaker 4 via the voice output unit 16.

Although not shown, the control unit 10 includes a central processing unit (CPU), a random access memory (RAM), etc. The CPU in the control unit 10 reads a program stored in a program storage 131 of the storage 13, deploys the program in a work area of the RAM, and executes various processing including information output processing according to the deployed program. The information output processing will be described later. The RAM in the control unit 10 is a volatile memory and has a work area for storing various programs executed by the CPU or data related to these programs, etc.

The operation unit 11 includes various function keys, cursor keys and the like, accepts key inputs by users, and outputs operation information on the key inputs to the control unit 10.

The display unit 12 includes a liquid crystal display (LCD) or the like and displays various information according to display control signals from the control unit 10.

The storage 13 includes a hard disk drive (HDD) or a nonvolatile semiconductor memory. The storage 13 further includes the program storage 131 and a video data storage 132.

The program storage 131 stores a system program and various processing programs executed by the control unit 10, data required for execution of these programs, etc. The programs are stored in the program storage 131 in the form of computer-readable program codes. The control unit 10 sequentially executes operations according to the program codes.

The video data storage 132 stores video data of video content. The video data includes projection images of respective frames (frame images) included in moving image data and voice data corresponding to the respective frames. The video data storage 132 stores the plurality of projection images, where orientations of a projection object are different, for each frame included in the video content.

The I/F 14 is connected to the output unit 3 and transmits or receives data to or from the output unit 3.

The I/F 15 is connected to human body sensors SE1 to SEn and transmits or receives data to or from the sensors. Communication with the human body sensors SE1 to SEn may be performed either in a wired or wireless manner.

The voice output unit 16 connected to the speaker 4 converts the voice data designated by the control unit 10 into voice signals and outputs the voice signals from the speaker 4.

The near field wireless communication unit 17 is a near field wireless communication interface in conformity to the international standard of near field wireless communication: NFC. The near field wireless communication unit 17 reads the model information of the communication terminal 2 including the model name and the use period through near field wireless communication.

The output unit 3 is, for example, a projector (the projection unit 24 in FIGS. 1 and 2) and a projection apparatus of a rear projection type that projects the video content from a back surface of the screen based on the projection image transmitted from the information output device 1. As for the output unit 3, for example, a digital light processing (DLP (registered trademark)) projector using a digital micromirror device (DMD) may be employed. The DMD performs, based on the projection image, a display action through individual high-speed on-off actions of respective tilt angles of multiple micromirrors (1024 pixels by 768 pixels for XGA) aligned in an arrayed manner, thereby forming an optical image from the reflected light. Turning on the micromirros in positions corresponding to an area of the projection object in the projection image and turning off the rest of the micromirrors in other areas allows for projecting only the projection object on the screen.

As for the human body sensors SE1 to SEn, for example, sensors, which can detect a human existence within a detection area by detecting a change in an ambient temperature using infrared rays or the like, may be employed. When detecting the human existence, the human body sensors SE1 to SEn report to the control unit 10 to turn on power of the information output device 1 via the control unit 10. Also when the human body sensors SE1 to SEn do not detect a human existence for a certain period of time after use of the information output device 1, the human body sensors SE1 to SEn report to the control unit 10 for transition of the information output device 1 to a power saving mode via the control unit 10.

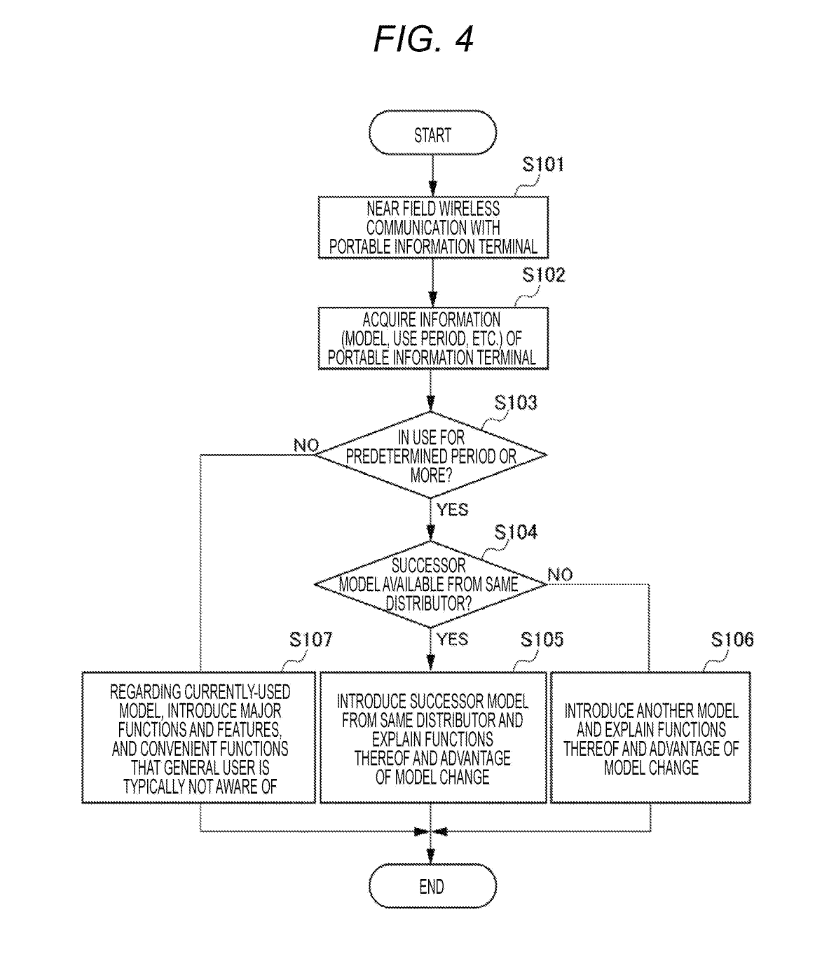

FIG. 4 is a flowchart showing operations of the information output device 1 according to the embodiment.

In the embodiment, a description is given for an example where a user is visiting a shop dealing with communication terminals such as smartphones, where the information output device 1 is installed, and receives an explanation from the information output device 1 instead of from a shop clerk.

As shown in FIG. 4, the information output device 1 performs near field wireless communication with the communication terminal 2 via the near field wireless communication unit 17 and reads the model information when the user possessing the communication terminal 2 such as a smartphone places the communication terminal 2 over the NFC panel 40 of the information output device 1 (step S101).

Thereafter, the control unit (acquisition unit) 10 acquires information on the model name, use period, etc. of the communication terminal 2 from the model information having been read via the near field wireless communication unit 17 and stores the information in the storage 13 (step S102). The information on the use period may be, for example, a use period stored in the communication terminal 2 or a date and time when the user started to use the communication terminal 2. When the date and time when the user started to use the communication terminal 2 is acquired, the use period may be acquired through comparison with the current date and time.

When the acquired information on the use period is less than a predetermined period (e.g. less than two years) (“NO” in step S103), the control unit 10 acquires the information on the model name from the communication terminal 2 and then outputs, to the output unit 3 (output unit), information on performance, features, etc. of the model based on the acquired model name.

Specifically, the control unit 10 converts, for the currently-used model, an explanation on major functions and features and information on convenient functions that general users are not aware of into image information via the I/F 14 and outputs the image information to the output unit 3 for projection onto the screen 23 while converting them into voice information via the voice output unit 16 for voice output from the speaker 4.

Note that a reason for assuming a period of less than two years here is because a use period of two years is typically specified upon signing a contract in the communication terminal distribution industry in general. Due to this, relatively a small number of users sign a new contract or change models in less than two years. Therefore, when the acquired information on the use period is less than the predetermined period (two years), a description is given on the major functions, etc. of the communication terminal 2 currently in possession.

On the other hand, when the acquired information on the use period is equal to or more than the predetermined period (“YES” in step S103), the control unit 10 acquires the information on the model name from the communication terminal 2.

Specifically, the control unit 10 acquires, from the storage 13, information on performance of the major functions, etc. of a related model registered in association with the name of the currently-used model (for example, a new model such as a successor model of the currently-used model having major functions similar to those of the currently-used model).

Thereafter, when another related (similar) model is available from the same distributor based on the acquired information on the model name (“YES” in step S104), the control unit 10 outputs information on the other model (step S105).

Specifically, the control unit 10 has the information on the successor model of the same distributor projected to the output unit 3 and output in voice from the speaker 4, thereby making an announcement where the differences in performance and functions between the currently-used model and the successor model are explained and advantages of a model change to the successor model are announced.

Note that a reason for assuming the successor model of the same distributor here is because a user tends to change to a model having similar or superior functions to the communication terminal 2 that the user currently possesses and having operation methods similar to those of the communication terminal 2 that the user currently possesses, when the user changes models after using the current communication terminal 2 for two years or more.

Note that when another model from the same distributor is not available (“NO” in step S104), the control unit 10 outputs information on, for example, another model from the same distributor which is a recommended item on promotion, thereby making an announcement where functions of the model are explained and advantages of a model change are announced (step S106).

Note that the information output in step S106 may be information on a popular model from a different distributor.

As described above, according to the information output device 1 of the embodiment, there can be provided an information output device that outputs information based on usage status of the communication terminal 2 by the user through communication between the communication terminal 2 and the information output device 1 whereby the model information is acquired.

Furthermore, use of the information output device 1 according to the embodiment, for example in a waiting time at the shop, allows the user to learn, in advance, information including that of the communication terminal 2 currently in possession or recommended models for a model change. This enhances understanding on items which may not be clear only from a written description in a brochure, thereby contributing to promotion of model changes to smartphones as a result.

Moreover, since the information output device 1 gives a general explanation on the communication terminal 2, the shop clerk is only required to follow up on the explanation and can mainly focus on purchase procedures. This results in higher investment effect. Also, a reduced burden on shop clerks and an improved turnover rate of attending customers can be expected.

Note that the embodiment has been described with the premise that the communication is performed by using near field wireless communication conforming to the NFC standard. However, the communication is not limited thereto and may use another standard for near field wireless communication such as Bluetooth (registered trademark) or wireless LAN.

Although the present invention has been described above with the embodiment, it shall be understood that the technical scope of the invention is not limited to the scope described for the above embodiment. It is apparent to those skilled in the art that various modifications or improvements can be applied to the embodiment. It is also apparent from the descriptions of claims that an embodiment including such modifications or improvements is also within the technical scope of the invention.

What is claimed is:

1. An information output device comprising:
a communication unit configured to receive, from a communication terminal, information on a use period of the communication terminal; and
an output unit configured to output information based on the received information on the use period.

2. The information output device according to claim 1,
wherein the output unit acquires information on a name of a model from the communication terminal and outputs information on the model based on the acquired name of the model when the information on the use period received by the communication unit is less than a predetermined period.

3. The information output device according to claim 2,
wherein the output unit acquires the information on the name of the model from the communication terminal and outputs information on another model similar to the communication terminal based on the information on the acquired name of the model when the information on the use period received by the communication unit is equal to or more than the predetermined period.

4. The information output device according to claim 3,
wherein the output unit outputs information on still another model when the other model similar to the communication terminal is not available.

5. The information output device according to claim 1,
wherein the communication unit communicates with the communication terminal in a non-contact manner.

6. A non-transitory computer-readable storage medium storing a program for causing a computer to execute the functions of:
acquiring, from a communication terminal, information on a use period of the communication terminal through communication therewith; and
outputting information based on the information on the use period.
